(19) United States
(12) Patent Application Publication
(10) Pub. No.: US 2009/0071347 A1
(43) Pub. Date: Mar. 19, 2009

(54) Toaster

(76) Inventor: Ji Seo Lee, Suwon City (KR)

Correspondence Address: IP STRATEGIES, 12 1/2 WALL STREET, SUITE E, ASHEVILLE, NC, 28801, US

(21) Appl. No.: 12/032,227

(22) Filed: Feb. 15, 2008

(30) Foreign Application Priority Data
Sep. 19, 2007 (KR) 20-2007-15634
Feb. 13, 2008 (KR) 20-2008-1887

(51) Int. Cl. A47J 37/08

(52) U.S. Cl. 99/341

(57) ABSTRACT

The present device is intended to provide a toaster comprising an opening and closing door installed on the toaster side walls or front wall, one of the support bars holding the bread formed to make a bigger gradient so that, whenever the door is open, the placement of bread may be done easily, and, when the door is closed, the holder may recover the original space, a heating control timer which automatically opens the door when the baking is finished, and the toaster housing a part of which is transparent so that the baking conditions of bread may be recognized.

### FIELD OF THE DEVICE

The present device relates to a toaster. Particularly, the present device relates to a toaster comprising an opening and closing door installed on the toaster side walls or front wall; a bread holder formed by a plurality of support bars to be installed on the inside of the opening and closing door; a support bar formed to constitute a holder supported and guided by a holder guide and form a bigger gradient when the door is open so that the placement of bread may be done easily, and recover the original position by the holder guide when the door is closed so that the support bars of the holder may support the bread; and a partially transparent heater housing and cover formed to enable to see through the baking conditions of bread.

### BACKGROUND OF THE DEVICE

In general, a toaster is a device for baking bread with two or more of holders formed in the inner part of the toaster so that the bread may be placed from the top of the holders, and, when the baking is done at the setting time, the bread may pop up.

Because the bread holders of a traditional toaster mentioned above are not adjustable, it is not easy to place the bread into the holder in case where the bread size is bigger, and, because the bread pops up above the top when the baking is done, the top should not be placed back for quite a while, causing the significant heat loss, and, further, because the setting time of toaster and the baking time of bread are not always same, if the baking conditions of bread can not be seen, it is likely to burn the bread.

### SUMMARY OF THE DEVICE

### The Objects of the Present Device

The present device is intended to provide a toaster comprising an opening and closing door on the toaster side walls or front wall that extends horizontally when the door is opened, a bread holder formed by a plurality of support bars on the inside of the opening and closing door mentioned above, and a guide pin formed on a cross bar of support bars in the interior part of toaster and connected to a holder guide inwardly widening and outwardly narrowing so that bread holders may widen when the opening and closing door is opened and narrow when the opening and closing door is closed, thereby placing the bread into the bread holder easily.

Also, the present device is intended to provide a toaster preventing heat loss by closing the opening and closing door while baking.

Further, the present device is intended to provide a toaster enabling to see through the baking conditions of bread.

### The Solutions of the Present Device

A toaster according to the present device forms an opening and closing door on the toaster side walls or front wall for easy manipulation.

A bread holder is installed on the inside of the opening and closing door and formed so that the operator may not scald his or her hand when separating the bread from the holder.

It being taken into consideration that the bread size varies depending upon the maker, the inlet of holder is comprised so that they may be widened by manipulation for an easy placement of bread into the holders.

The inlet of holder is comprised so that they may be widened according to the change in position of a plurality of support bars forming the holder

A holder guide is formed to widen inwardly and narrow outwardly of the toaster, and a guide pin is formed on the cross bar of the support bars constituting the holder and fixed on the holder guide so that the guide pin may move along with the guide holder, thereby the gradient formed by the support bars becomes bigger or smaller as the guide pin moves back and forth with the holder guide and, accordingly, the inlet of holder is to widen or narrow.

The toaster in overall is formed transparent and comprised so that the baking conditions of bread may be seen.

### BEST MODE

A toaster according to the present device brings about an effect for the easy separation and placement of bread.

A toaster according to the present device brings about an effect for preventing heat loss while baking.

A toaster according to the present device enables to show the baking conditions of bread, thereby bringing about an effect for preventing the bread loss due to the overly baking.

### BRIEF DESCRIPTION OF THE DRAWING

FIG. 1 illustrates an overall view of the toaster according to the present device.

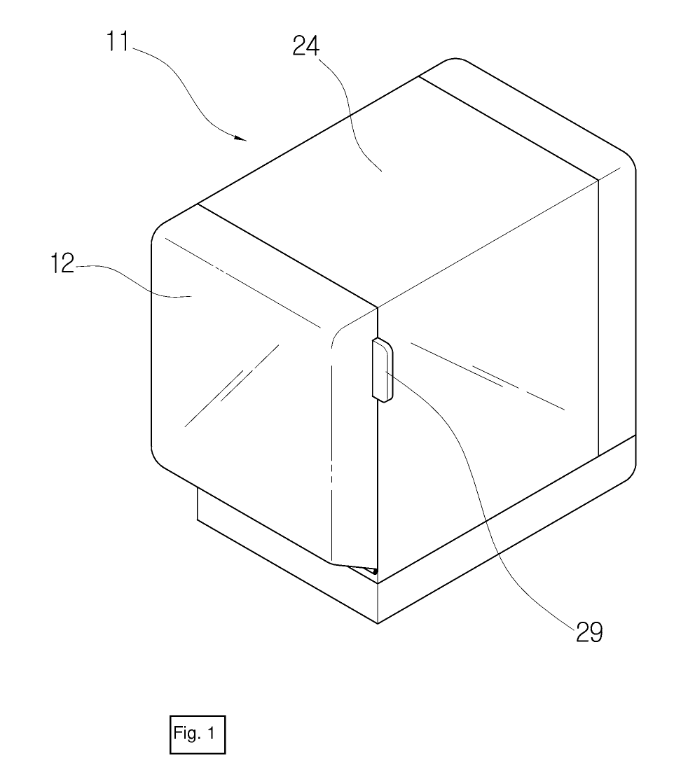

FIG. 2 illustrates an operational configuration of the toaster according to the present device.

FIG. 3 illustrates a horizontal sectional view of the toaster according to the present device.

FIG. 4 illustrates an assembled state of the toaster according to the present device.

FIG. 5 illustrates a working state of the bread holder according to the present device.

FIG. 6 illustrates a side view of the toaster according to the present device.

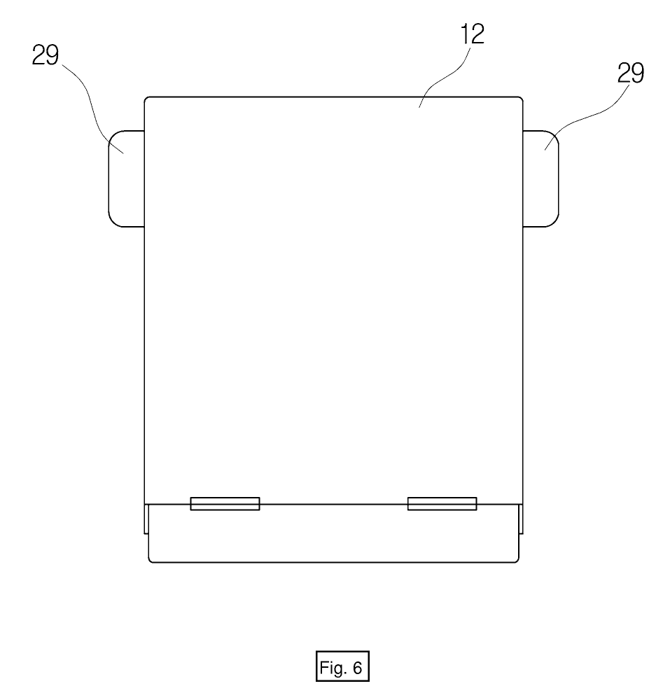

### DESCRIPTION OF THE MAJOR PARTS OF THE DRAWING

| | |
|---|---|
| 11: Body | 12: Opening and Closing Door |
| 13: Bread Holder | 14: Bread |
| 15: Bread Holder Guide | 16: Guide Pin |
| 17: Support Bar (a, b) | 18: Cross Bar |
| 19: Horizontal Support Bar (a, b) | 21: Fixing Member |
| 22: Spring | 23: Halogen Heater |
| 24: Transparent Glass | 25: Heat Resistant Glass |
| 26: Electromagnetic Contacts (a, b) | 27: Control Panel |
| 28: Drawer | 29: Handle |
| 31: Control Switch | 32: Waste Collecting Hole |
| 33: Frame | |

### DETAILED DESCRIPTION OF THE PREFERRED EMBODIMENT

The present device is described in detail with reference to the drawings.

The present device is formed to provide the opening and closing door (12) which can be opened or closed and sideward or frontward.

The bread holder (13) according to the present device is installed on the inside of the opening and closing door (12).

A plurality of the support bars (17a, 17b) according to the present device form the bread holder (13) in two arrays.

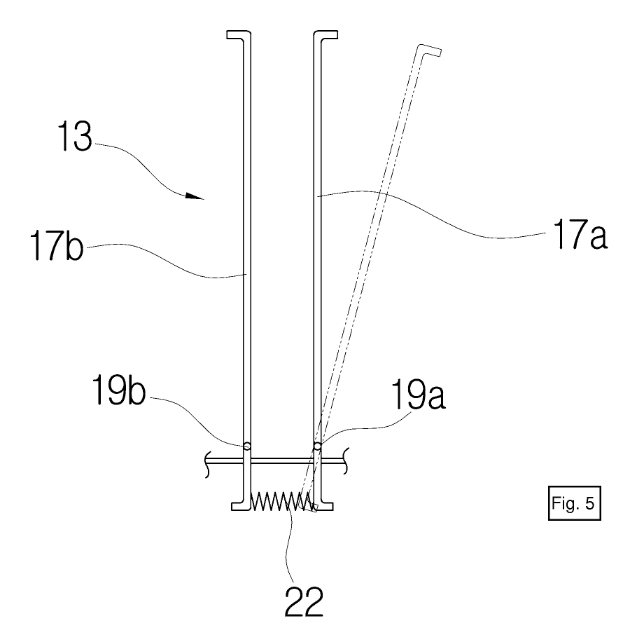

As illustrated in FIG. 5, the horizontal support bar (19a) is formed to be fixed on the end of the support bar (17a) of the coupling support bars (17a, 17b) of the bread holder (13) according to the present device and the spring (22) is formed on the end of the support bar (17b) so that the rotary movement of the support bar (19a) and the spring (22) may widen or narrow the space between the bread holders (13).

The inner part of the body (11) is characteristic of the bread holder guide (15) installed therein.

The body (11) according to the present device in overall is formed transparent so that the inner part may be seen.

The part of the body (11) close to the heater (23) is covered by the heat resistant glass (25).

The plastic glass (24) is formed in the exterior of the heat resistant glass (25), and comprises the body (11).

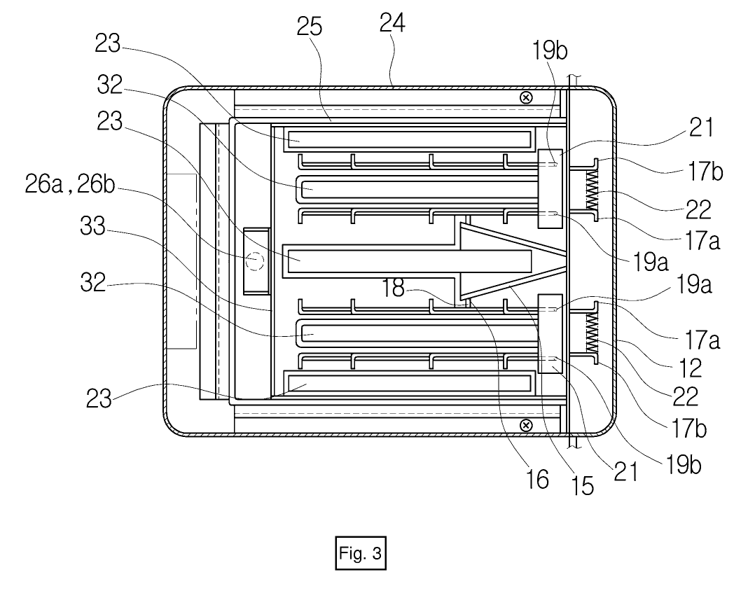

As illustrated in FIG. 3, the heaters (23) are arranged in the lower part of the body (11), and, as illustrated in FIG. 3, the electromagnetic contact (26a) is formed on one end of the lower part of the body (11) between the heaters (23)

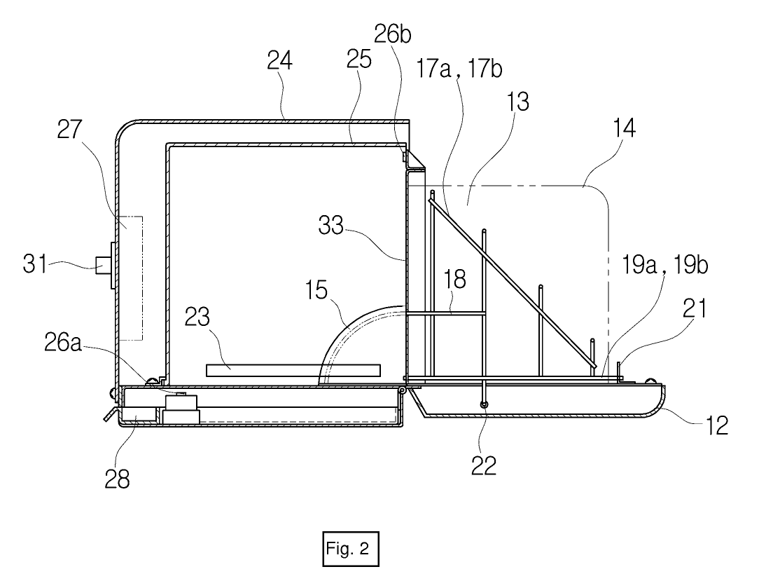

As illustrated in FIG. 2, in the outer electromagnetic contact (26a) is formed the drawer (28) for gathering bread waste, which can be opened or closed.

As illustrated in FIGS. 2 and 3, the bread holder guide (15) is formed in the lower part of the body (11).

The control panel (27) not exposed is formed in one side (right hand side) of the body (11) and outside of the control panel (27) is formed the control switch (27) for time setting.

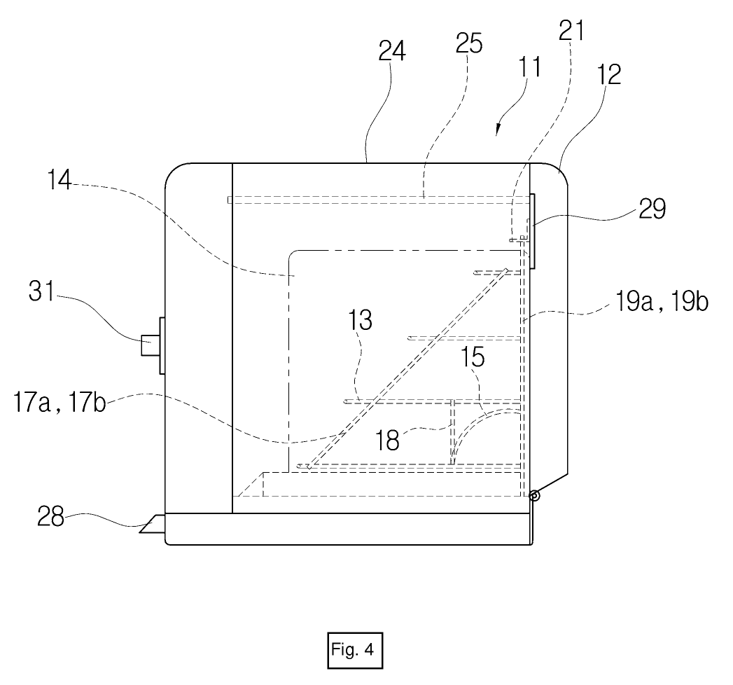

As illustrated in FIGS. 2 and 4, the opening and closing door (12) is formed to hinge on one side (left hand side) of the body (11) so that the opening and closing door (12) may be opened or closed.

The bread holder (13) is formed inside of the opening and closing door (12) as illustrated in FIGS. 2 and 4.

The bread holder (13) described above is comprised of a plurality of the support bars (17a, 17b), the horizontal support bars (19a, 19b) fixing the said support bars (17a, 17b), the cross bar (18) with the guide pin (16) fixed on, the fixing member (21) fixing the said the horizontal support bars (19a, 19b), and the frame (33).

The horizontal support bar (19a), one of the horizontal support bars (19a, 19b) mentioned above is fixed so that the horizontal support bar (19a) may make a rotary movement at the fixing member (21) and the frame (33), and the other horizontal support bar (19b) is merely fixed on the horizontal support bar (19b).

As illustrated in FIG. 2, the lower end of the support bar (17b) of the coupling support bars (17a, 17b) mentioned above is exposed below the horizontal support bars (19a, 19b), and the spring (22) is fixed to the end of the support bar (17b).

The horizontal support bar (19a) making a rotary movement and the support bar (17b) fixed on the horizontal support bar (19a) by the spring (22) as described above are formed to make a rotary movement from side to side to the maximum elasticity limit of the spring (22).

The sticking-out guide pin (16) is fixed on the cross bar (18) as illustrated in FIG. 3, which crosses the support bars (17a, 17b) and is fixed thereto as illustrated in FIG. 2, and the said guide pin (16) is formed so that the said guide pin (16) combined with the bread holder (15) move together.

The electromagnetic contact (26) is formed in the rear end of the opening and closing door (12) and on the upper part of the frame (33) which supports the opening and closing door (12),

Now the composition and operation of the present device will be described based on an actual example.

As illustrated in FIG. 3, on the lower part of the body (11), the heaters (23) were placed in three rows and the waste collecting hole (32) was formed between the heaters (23) to collect the bread waste.

The drawer (28) in the connection with the said waste collecting hole (32) was formed for the accommodation of the bread waste that comes through the waste collecting hole (32) and separable for the disposal of the accumulated bread waste.

On the bottom of the body (11), the two bread holder guides (15) were formed and, when viewed from above, forms a triangle pointing to the right as illustrated in FIG. 3, and, when viewed from the front, a quarter of a round as illustrated in FIG. 2, and, also, the bread holder guide (15) and the heater (23) were formed.

In the inner part of the opening and closing door (12), the guide pin (16) was formed on the cross bar (18) of the bread holder (13) so that the guide pin (16) may move along the bread holder guide (15), therefore, when the guide pin (16) combined with the bread holder guide (15) moves, the bread holder (13) with the cross bar (18) formed on moves from side to side according to the shape of the bread holder guide (15), subsequently, the space of the bread holder (13) widens or narrows, and, when the opening and closing door (12) is opened, the said space widens, making it easy to place the bread.

As the guide pin (16) was combined with the bread holder guide (15) as described in the above, the guide pin (16), when the opening and closing door (12) is opened, moves toward the narrowing direction as illustrated in FIG. 3, thereby widening the space of the bread holder (13) as illustrated in FIG. 5.

As the space of the bread holder (13) widens as described in the above, the space of the lower end of the support bar (17b) of the coupling support bars (17a, 17b) narrows, contracting the spring (22).

When the opening and closing door (12) is closed, the guide pin (16), moves toward the widening direction as illustrated in FIG. 3, narrows the space of the bread holder (13), recovers the original space of the bread holder (13) by the force of repulsion of the spring (22), and supports the placed bread, then the heater (23) is turned on.

In the inner wall of the body (11) was formed an image sensor (not illustrated) sensing the placed bread and turning the heater (23) on so that, when the bread is not placed, the sensor may not operate so the heater (23) does not turn on even if the opening and closing door (12) is closed.

The time required for baking the bread (14) is set up by the control switch (31).

When the opening and closing door (12) is opened, the bread holder guide (15) widens the spaces of the two couples of the bread holders (13). After the opening and closing door (12) is opened so the bread holder (13) widens, the bread (14) is placed in the bread holder (13).

When the bread (14) is placed and the opening and closing door (12) is closed, the electromagnetic contact (26b) formed on the upper frame (33) of the opening and closing door (12) and the electromagnetic contact (26b) formed on the bottom of the body as illustrated in FIG. 2 are combined, locking up the opening and closing door (12) and body (11).

As described above, the opening and closing door (12) is closed at the same time the electric power turns on.

When the electric power turns on, the electromagnetic contacts (26a, 26b) activate an electromagnet to firmly lock up the opening and closing door (12) and the body (11).

When the opening and closing door (12) is closed as described above, the heating state of the heater (23) and the baking conditions of the bread (14) can be seen through the transparent glass (24, 25).

Upon the completion of the setting time, the heating of the heater (23) stops and the electric power turns off.

When the electric power turns off, the electromagnet of the electromagnetic contact (26a) stops activating and, when the opening and closing door (12) is opened by the handle (29), the opening and closing door (12) extends horizontally, the bread holder (13) is exposed on the opening and closing door (12), and the space between the bread holder (13) widens, there-from enabling to separate the baked bread easily.

When the bread waste from the repeated use of toaster as described above accumulate in the waste collecting hole (32), the toaster may be tipped slightly so that the bread waste may gather into the drawer (28), which can be separated for waste clean-up.

What is claimed is:

1. A toaster characteristic of the composition comprising:
the opening and closing door (12) which can be opened or closed and frontward or sideward;
the bread holder (13) formed on the inside of the said opening and closing door (12) and integrated with the said opening and closing door (12) so that the bread may be placed;
the drawer (28) enabling to accommodate the bread waste;
the electromagnetic contacts (26a, 26b) which firmly fix the opening and closing door (12) to the body (11); and
the body (11) formed transparent, enabling to recognize the baking conditions of bread.

2. The toaster as claimed in claim 1, characteristic of the formation:
a plurality of the support bars (17a, 17b) forming in two arrays the bread holder (13) formed on the inside of the opening and closing door (12);
the lower end of each of the support bars (17a, 17b) formed to be fixed to horizontal support bars (19a, 19b);
the lower end of the support bar (17a) of the support bars (17a, 17b) formed to be exposed below the horizontal support bar (19a);
the lower end of the support bar (17b) symmetrical with the support bar (17a) formed to be connected with the spring (22); and
the horizontal support bar (19a) formed to be fixed to the fixing member (21) and the frame (33) so that the horizontal support bar (19a) may make a rotary movement so one side of the bread holder (13) may make a rotary movement from side to side.

3. The toaster as claimed in claim 1, characteristic of the composition comprising:
the bread holder guide (15) formed on the bottom of the body (11) so that the bread holder guide (15) may widen toward the inside of body (11) and narrow toward the opening and closing door (12); and
the guide pin (16) of the cross bar (18) formed on the support bars (17a, 17b) of the bread holder (13) to be connected with the bread holder guide (15) so that the space of the bread holder (13) may widen or narrow as the guide pin (16) moves together with the bread holder guide (15).

4. The toaster as claimed in claim 1, characteristic of the composition comprising:
the electromagnetic contact (26a) formed on the bottom of the body (11) and the electromagnetic contact (26b) formed on the upper part of the opening and closing door (12) so that, when the electric power turns on, the electromagnetic contacts (26a, 26b) may lock up the body (11) and the opening and closing door (12); and
an image sensor formed in the inner part of the body (11) so that the placement of bread may be sensed.

5. The toaster as claimed in claim 1, characteristic of the composition comprising:
the heat-resistant glass (25) formed in the exterior of the heater (23) and the bread holder (13) so that the baking conditions of bread may be recognized as the body (11) and the opening and closing door (12) are locked up and also the heat loss may be prevented; and
the plastic glass (24) formed in the exterior of the heat resistant glass (25).
